(19) United States
(12) Patent Application Publication
(10) Pub. No.: US 2026/0061527 A1
(43) Pub. Date: Mar. 5, 2026

(54) WELD SEAM ASSESSMENT

(71) Applicant: Georg Fischer Rohrleitungssysteme AG, Schaffhausen (CH)

(72) Inventor: Riccardo BARBONE, Schaffhausen (CH)

(21) Appl. No.: 19/314,564

(22) Filed: Aug. 29, 2025

(30) Foreign Application Priority Data
Sep. 3, 2024 (EP) 24198094.5

(51) Int. Cl. B23K 31/12; B23K 31/00; B23K 31/02; B23K 103/00; G01N 29/04; G01N 29/44

(52) U.S. Cl. CPC B23K 31/125; B23K 31/006; B23K 31/02; G01N 29/041; G01N 29/048; G01N 29/4481; B23K 2103/42

(57) ABSTRACT

Computer-implemented method and system for assessing a non-destructive ultrasonic test on a plastic pipe weld, including:
receiving an ultrasound scan file by way of a server,
a computing unit analyzing the ultrasound scan file based on predefined criteria, wherein the computing unit comprises a neural network,
the computing unit assessing the ultrasound scan file based on the predefined criteria.

### CROSS-REFERENCED TO RELATED APPLICATIONS

This application claims the benefit and priority of European Patent Application No. 24198094.5 filed Sep. 3, 2024. The entire disclosure of the above application is incorporated herein by reference.

### BACKGROUND OF THE INVENTION

### Technical Field

The invention relates to a computer-implemented method for assessing a non-destructive ultrasonic test on a plastic pipe weld, to a system for assessing a non-destructive ultrasonic test on a plastic pipe weld, and to a method for training a neural network for use in a method for assessing a non-destructive ultrasonic test on a plastic pipe weld.

### Discussion

Nowadays, plastic pipeline welds produced on construction sites are tested by way of an ultrasonic test, wherein the ultrasonic test is carried out by an inspector, who uses the ultrasound scan to assess whether the weld meets the requirements and has passed, or does not meet the requirements and has failed. The inspector usually does not carry out the assessment themselves on site, but rather forwards the ultrasound scan to a test center, which visually assesses the ultrasound scan through a visual inspection performed by an examiner and sends the inspector an assessment as to whether the weld seam has passed or failed. The disadvantage here is that the assessment usually comes back to the inspector hours or even days later and, in the event of a negative assessment, another weld has to be produced and subsequently checked, and it is thus necessary to revisit the construction site, which is all highly time-consuming and expensive.

EP 3 815 884 A1 discloses a method for testing a weld, in which the weld that is produced is recorded by way of a data processing device, and also defects are detected by way of ultrasound and stored.

The disadvantage here is that the system does not assess the weld seam directly, but rather the inspector has to send the ultrasonic test to the test center for assessment or has to instruct the test center to test and assess the data fed into the web-based tool, which usually causes hours or days of delays.

An aspect of the invention is to propose a computer-implemented method, an associated system and a method for training a neural network that provides an assessment of an ultrasound scan of a plastic pipe weld in real time, and evaluation times of the ultrasound scans are thereby able to be reduced significantly.

### SUMMARY

This aspect is achieved, in that a computer-implemented method for assessing a non-destructive ultrasonic test on a plastic pipe weld includes the following steps:
receiving an ultrasound scan file by way of a server,
the computing unit analyzing the ultrasound scan file based on predefined criteria, wherein the computing unit comprises a neural network,
the computing unit assessing the ultrasound scan file based on the predefined criteria.

The computer-implemented method according to the preferred embodiment of the invention for assessing a non-destructive ultrasonic test on a plastic pipe weld includes receiving an ultrasound scan file by way of a server. The server may include a computing unit and/or a memory, and may also be in the form of a GPU. The ultrasound scan file may be transmitted directly to the server from an ultrasound scanner, and also be sent or transferred to the server in some other way, for example using a USB stick or via Bluetooth, wherein it is advantageous for the server to be web-based and for the server thus to be able to be accessed over the Internet and for the ultrasound scan files to be able to be transmitted and received by the server. An ultrasound scan file is an image of an ultrasound scan of a plastic pipe weld, the weld to be tested. Preferably, the ultrasound scan file shows the complete all-round weld extending over 360°. The computer-implemented method according to the invention includes the ultrasound scan file being analyzed by a computing unit based on predefined criteria. Preferably, the computing unit is part of the server, but it may also be designed autonomously. The computing unit comprises a neural network or a learning algorithm, preferably a convolutional neural network (CNN) that analyzes and assesses the ultrasound scan files. The final assessment is made based on the assessment of the ultrasound scan file on the basis of the predefined criteria, preferably as “passed” or “failed”.

Preferably, the ultrasound scan files are stored on the server or an alternative storage module.

Preferably, the predefined criteria and sub-criteria are stored in a database on the server or an alternative storage module and are continuously expanded by new ultrasound scan files and their assessment. The database may also be stored at a location other than the server.

It is advantageous for the criteria to be divided into test groups. This allows efficient testing and fast assessment by the computing unit, so that poor-quality ultrasound scan files are not even checked for the quality of the weld in the first place, but rather the assessment is terminated early.

Preferably, a test group defines the quality of the ultrasound scan file. It is advantageous for the computing unit to first assess the ultrasound scan file with respect to the test group of the quality of the ultrasound scan file, preferably by way of the neural network. If the ultrasound scan file is assessed such that it is classed as “failed,” the test is terminated and a notification is output that the ultrasound scan file has “failed”. This notification is preferably displayed directly to the inspector on site via a display device and, if necessary, also forwarded to the test center via the web-based platform. As a result, another ultrasonic test is carried out and a new ultrasound scan file is transmitted to the server in order then to have it analyzed and assessed by the computing unit.

It is advantageous for the quality of the ultrasound scan file to be assessed, inter alia, based on the criterion of the profile of the displayed shaft in the ultrasound scan file towards the outer surface of the weld seam and the pipe. Sub-criteria preferably include whether the shaft runs continuously without interruptions, whether the shaft is formed uniformly, and also whether scratches are visible in the shaft. Of course, the list is not exhaustive and may be supplemented with further sub-criteria.

Preferably, the quality of the ultrasound scan file is assessed, inter alia, based on the criterion of the profile of the displayed shaft in the ultrasound scan file towards the inner surface of the weld seam and the pipe. Sub-criteria preferably include whether the shaft runs continuously without interruptions, whether the shaft is formed uniformly, and also whether scratches are visible in the shaft. Of course, the list is not exhaustive and may be supplemented with further sub-criteria.

It is advantageous for the quality of the ultrasound scan file to be assessed, inter alia, based on the criterion of the profile of the wall thickness in the ultrasound scan file of the weld seam and the pipe. This preferably includes the sub-criterion as to whether the wall thickness is constant over the ultrasound scan file or is of equal width. In addition, the wall thickness may also be tested and assessed for irregularities in the ultrasound scan as a further sub-criterion. Of course, the list is not exhaustive and may be supplemented with further sub-criteria.

It is advantageous for the quality of the ultrasound scan file to include, inter alia, due to the criterion of the presence of a heating wire in the ultrasound scan file. This criterion is applied when an ultrasonic test of a weld by way of an electrofusion coupler is present. Preferably, the number of recognizable heating wires or windings is also tested, along with the thickness or diameter of the heating wire that is present. If the processing unit is not able to recognize this, the ultrasound scan file is classed as insufficient and must be recreated.

It is advantageous for the quality of the ultrasound scan file to be assessed, inter alia, based on the criterion as to whether cold zones are recognizable in the ultrasound scan file. It is also advantageous to include the length of the cold zones as a quality criterion for the ultrasound scan.

It is advantageous for the quality of the ultrasound scan file to be assessed, inter alia, based on the criterion of the settings of the ultrasound scan performed on the weld seam and the pipe. This preferably includes the sub-criterion of the speed of creation of the ultrasound scan file and also the recognition of the zero line or the calibration of the ultrasound scanner for the correct acquisition of the ultrasound scan file. Of course, the list is not exhaustive and may be supplemented with further sub-criteria.

It has proved to be advantageous for the individual criteria to be assessed based on a percentage deduction starting from a base of 100%. In other words, if for example, in the ultrasound scan file quality test group, the criterion of the outer surface is tested and the computing unit recognizes that the profile of the shaft is not continuous, then an assessment of for example 2% is output due to defects in the shaft, which is then subtracted from the starting optimum base value of 100%.

It is advantageous for such an assessment to be carried out by the computing unit for each criterion or sub-criterion.

It has proved to be advantageous for the computing unit, in the event of a failed test regarding the quality of the ultrasound file, to output suggestions for achieving a sufficient quality of the ultrasound scan file, for example cleaning the test center, etc.

Preferably, following the testing and assessment of the criteria of the ultrasound scan file quality test group, the criteria of the weld quality test group are tested and assessed by way of the computer-implemented method according to the invention.

It has proved to be a preferred embodiment for the quality of the weld to be tested and assessed based on least one of the criteria of anomalies, defects, or inconsistent, unexpected structures in the ultrasound scan file, no heating wire recognizable. Of course, the list is not exhaustive and may be supplemented with further criteria.

Preferably, the ultrasonic test for creating the ultrasound scan file is carried out by way of time-of-flight diffraction (TOFD) or the phased-array ultrasonic test (PAUT).

Preferably, butt welds, electrofusion welds with electrofusion couplers and also other plastic pipe welds are assessed. The predefined criteria are stipulated depending on the plastic pipe weld to be analyzed, for example that a heating wire check is applied only where a heating wire is also used.

This aspect is also achieved, according to the preferred embodiment of the invention, by a system according to the invention for assessing a non-destructive ultrasonic test on a plastic pipe weld including an ultrasound scanner for carrying out an ultrasound scan on a plastic pipe weld and for creating an ultrasound scan file, a server for receiving the ultrasound scan file, a computing unit for analyzing the ultrasound scan file and for assessing the ultrasound scan file based on the predefined criteria, wherein the computing unit comprises a neural network and an output unit for displaying the assessment. Preferably, the final assessment is given as “passed” or “failed”. The ultrasound image of the weld as acquired by the ultrasound scanner is transmitted to a server and is received thereby. A web-based platform to which the ultrasound scan file is sent is preferably used for this purpose, wherein the ultrasound scan file may also be transmitted to the server in other ways. It is advantageous for the server to have a computing unit and a memory, but the units may also be arranged separately from one another. A computing unit analyzes and assesses the ultrasound scan file based on the criteria that have already been listed in the above text concerning the computer-implemented method. The computing unit analyzes and assesses the criteria using a neural network. The assessment is communicated to the inspector on site on an output unit.

It is advantageous for the server to have a web-based interface. This allows the ultrasound scan file to be accessed on site by the inspector at the construction site, and also from the test center.

This aspect is also achieved, according to the invention, in that a method according to the invention for training a neural network for use in a method for assessing a non-destructive ultrasonic test on a plastic pipe weld includes the following steps:
creating simulated ultrasound scan files by way of the neural network of the computing unit based on known ultrasound scan files of different materials, assessing the ultrasound scan files based on the criteria,
continuously expanding the neural network based on the simulated ultrasound scan files.

Preferably, the server or the computing unit has a simulation unit that is able to create further ultrasound files based on known materials with the aid of the neural network, as a result of which the variety of the ultrasound files to be used for the assessments is enlarged and the database is expanded. This makes it possible to reduce mainly intermediate ranges, ensuring that no indifferent assessments are created.

It s advantageous for the method for training a neural network for use in a method for assessing a non-destructive ultrasonic test on a plastic pipe weld to have at least one of the following criteria as a predefined criterion: a profile of the displayed shaft in the ultrasound scan file towards the outer or inner surface of the weld seam and the pipe, a profile of the wall thickness in the ultrasound scan file of the weld seam and the pipe, an anomaly, a defect, or an inconsistent, unexpected structure in the ultrasound scan file, or no heating wire is present. Of course, other criteria may also be used to train the neural network, and also the criteria mentioned above in relation to the method may be used to train the neural network.

It is advantageous for training or a database expansion to be carried out periodically or for this also to be done automatically upon each new assessment of an ultrasound scan file.

It has proved to be advantageous for the neural network to be a convolutional neural network (CNN). The neural network or the learning algorithm is trained to receive the ultrasound scan file of the weld as input in order to determine therefrom comparable criteria of the ultrasound scan files that are present. Setting values, material data or welding parameters may also be used for support, these possibly likewise being present in the neural network.

All possible embodiments may be combined freely with one another and, to avoid repetitions, the features of the computer-implemented method and of the system also automatically refer to the training method and vice versa.

### BRIEF DESCRIPTION OF THE DRAWINGS

An exemplary embodiment of the invention will be described with reference to the figures, the invention not being limited to just the exemplary embodiment. In the figures:

FIG. 1 shows a flowchart of the computer-implemented method according to the invention, and

FIG. 2 shows an ultrasound file with marked defects.

### DESCRIPTION OF THE PREFERRED EMBODIMENTS OF THE INVENTION

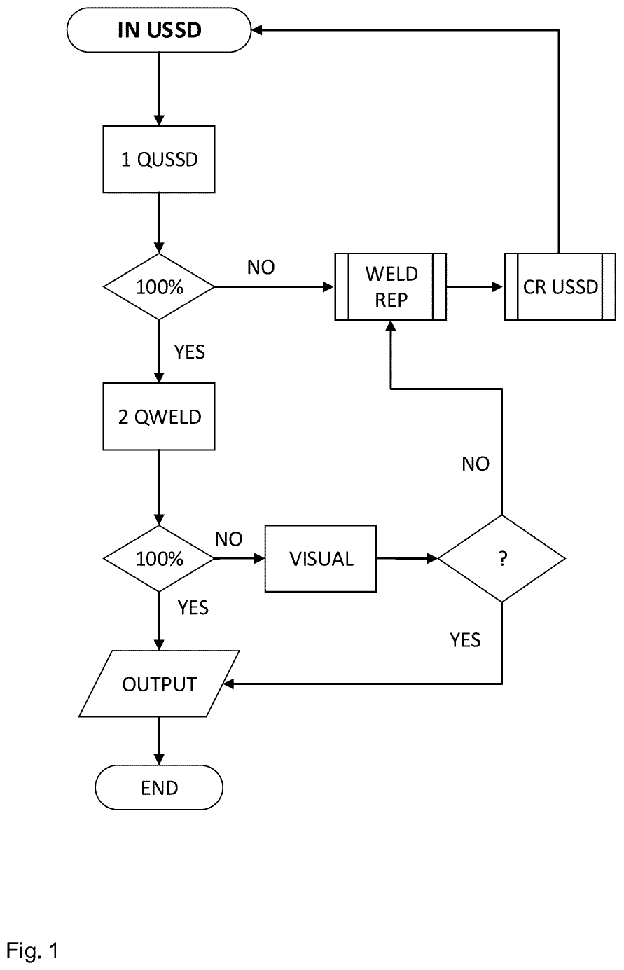

FIG. 1 shows a flowchart of a computer-implemented method according to the invention for assessing a non-destructive ultrasonic test on a plastic pipe weld. The ultrasound file USSD is received by way of a server IN USSD. Predefined criteria are then analyzed and assessed by a computing unit.

The analysis and assessment 1 QUSSD refers to the quality of the ultrasound file USSD in order to ensure that a further evaluation of the weld is carried out only with an ultrasound scan file that meets the requirements. The criteria of the 1 QUSSD of the first test group thus refer to the quality of the scan. Preferably, the criteria for the analysis and assessment of the ultrasound scan file are the profile of the displayed shaft in the ultrasound scan file towards the outer and inner surface of the weld seam and the pipe and/or the profile of the wall thickness in the ultrasound scan file of the weld seam and the pipe. This includes for example sub-criteria as to whether the shaft runs continuously without interruptions, whether the shaft is formed uniformly, or else whether scratches are visible in the shaft. Of course, the list is not exhaustive and may be supplemented with further sub-criteria, or else only individual ones of the listed criteria may be selected.

As one sub-criterion of the profile of the wall thickness in the ultrasound scan file of the weld seam and the pipe, for example, it is analyzed and assessed whether the wall thickness is constant over the ultrasound scan file. In addition, the wall thickness may also be tested and assessed for irregularities in the ultrasound scan as a further sub-criterion.

It has proved to be advantageous for the individual criteria to be assessed based on a percentage deduction starting from a base of 100%. In other words, if for example, in the ultrasound scan file USSD quality test group, the criterion of the outer surface is tested and the computing unit recognizes that the profile of the shaft is not continuous, then an assessment of for example 2% is output due to defects in the shaft, which is then subtracted from the starting optimum base value of 100%.

For the first ultrasound scan file quality test group, such an assessment may appear as follows:

1^{st} ultrasound scan file quality test group

| Criteria | Sub-criteria | Assessment |
|---|---|---|
| Profile of the displayed shaft | | |
| in the ultrasound scan file of | | |
| the inner surface | | |
| | Shaft continuous | 0 |
| | Shaft formed uniformly | 2% |
| | Scratches in the shaft | 0 |
| Profile of the displayed shaft | | |
| in the ultrasound scan file of | | |
| the outer surface | | |
| | Shaft continuous | 0 |
| | Shaft formed uniformly | 0 |
| | Scratches in the shaft | 0 |
| Wall thickness profile | | |
| | Constant profile of wall | 2% |
| | thickness | |
| | Irregularities in the wall | 0 |
| | thickness | |
| Ultrasound scan file settings | | |
| | Speed | 4% |
| | Zero line present | 0 |
| Total | | 92% |
| Assessment | | failed |

It may be seen here that the assessment revealed that the quality of the ultrasound scan file according to 1 QUSSD is not sufficient. It may thus be seen in the flowchart in FIG. 1 that this is followed by the step of replacing the weld WELD REP, and the welding point would be removed and recreated. Another ultrasonic test CR USSD is then carried out and the created ultrasound scan file is transmitted to the server again or received again thereby. The ultrasound scan file then runs through the first test 1 QUSSD again.

1^{st} ultrasound scan file quality test group

| Criteria | Sub-criteria | Assessment |
|---|---|---|
| Profile of the displayed shaft | | |
| in the ultrasound scan file of | | |
| the inner surface | | |
| | Shaft continuous | 0% |
| | Shaft formed uniformly | 0% |
| | Scratches in the shaft | 0% |
| Profile of the displayed shaft | | |
| in the ultrasound scan file of | | |
| the outer surface | | |
| | Shaft continuous | 0% |
| | Shaft formed uniformly | 0% |
| | Scratches in the shaft | 0% |
| Wall thickness profile | | |
| | Constant profile of wall | 0% |
| | thickness | |
| | Irregularities in the wall | 0% |
| | thickness | |
| Ultrasound scan file settings | | |
| | Speed | 0% |
| | Zero line present | 0% |
| Total | | 100% |
| Assessment | | passed |

It may be seen here that 100% has been achieved and the first ultrasound scan file quality test has thus been passed.

This is followed by the second test, that on the weld 2 QWELD. In this case too, the individual criteria are preferably assessed using percentages. If for example abnormalities occur, they are assessed based on their size, shape and quantity with a corresponding percentage, which then allows the weld to be calculated.

2^{nd} weld quality test group

| Criteria | Specification | Assessment |
|---|---|---|
| Anomalies | | |
| | Quantity | 6% |
| | Size | 1% |
| | Shape | 3% |
| Defects | | |
| | Quantity | 0% |
| | Size | 0% |
| | Shape | 0% |
| inconsistent, unexpected | | |
| structures | | |
| | Quantity | 1% |
| | Size | 2% |
| | Shape | 1% |
| Total | | 86% |
| Assessment | | failed |

The above example shows an assessment based on which the weld has failed. Following such an assessment, the ultrasound scan file USSD is transmitted to a test center or is provided for the test center on the web-based platform so as to allow the test center to perform a visual inspection. The test center then assesses the ultrasound scan file visually by way of a human examiner. Thus, the assessment given by the neural network as a failed weld is then assessed by the examiner, which ultimately determines whether the weld meets the requirements and has passed or does not meet the requirements and the weld has to be removed and the process is restarted.

If the test center assesses the weld with “YES”, the output unit OUTPUT outputs that the weld has passed, either through a digital display device or else through a printout.

If the system according to the invention comprising a neural network assesses the weld as 100%, an assessment carried out by a test center is no longer necessary and the assessment goes directly to the output unit OUTPUT with an assessment “passed”; see below in the table.

2^{nd} weld quality test group

| Criteria | Specification | Assessment |
|---|---|---|
| Anomalies | | |
| | Quantity | 0% |
| | Size | 0% |
| | Shape | 0% |
| Defects | | |
| | Quantity | 0% |
| | Size | 0% |
| | Shape | 0% |
| inconsistent, unexpected | | |
| structures | | |
| | Quantity | 0% |
| | Size | 0% |
| | Shape | 0% |
| Total | | 100% |
| Assessment | | passed |

Of course, the assessments are individually adaptable. It is also conceivable for 100% not to have been reached in order to pass, but rather the value may be 90% or some other specifically defined value.

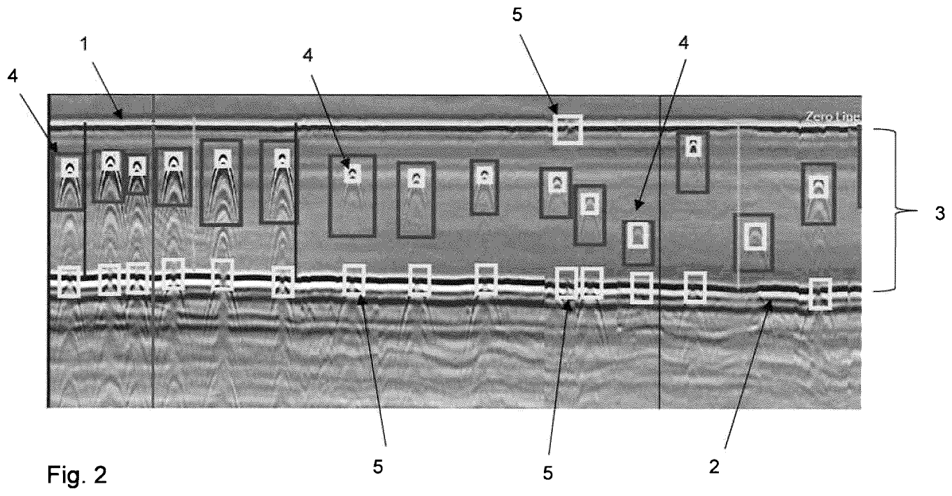

FIG. 2 shows an ultrasound scan file USSD, wherein here, as an example, both the first and the second test would not pass and both tests were carried out, wherein the process would generally be terminated after the first scan quality test were it not to have passed. The continuous and uniform profile of the shaft on the inner and outer surface 1, 2 is clearly visible, except for points 5, where it is apparent that the surfaces are not continuous. However, the wall thickness is constant. These criteria and sub-criteria would thus be assessed with a certain percentage and the first ultrasound scan file quality test would not be 100%, thus failed. However, the ultrasound scan file USSD also shows some defects in the structure, which have also been surrounded with a frame, wherein the computer-implemented method preferably identifies such sites, as may be seen by frames in FIG. 2. The computer-implemented method according to the invention has assessed the defects in the ultrasound scan file USSD, wherein the values are not present here, but the final value did not reach 100% in the second weld quality test, and therefore the ultrasound scan file USSD was passed to a test center in order to have a visual inspection performed by an examiner. Given the high number of defects, the examiner also assessed the weld as failed in this test image in FIG. 2 and instructed the inspector to remove the weld and have it tested again.

It is advantageous for the quality of the ultrasound scan file to be assessed based on the criterion of the settings of the ultrasound scan performed on the weld seam and the pipe. This preferably includes the sub-criterion of the speed of creation of the ultrasound scan file and also the recognition of the zero line or the calibration of the ultrasound scanner for the correct acquisition of the ultrasound scan file. Of course, the list is not exhaustive and may be supplemented with further sub-criteria.

What is claimed is:

1. A computer-implemented method for assessing a non-destructive ultrasonic test on a plastic pipe weld, comprising:
receiving an ultrasound scan file (USSD) by way of a server,
a computing unit analyzing the ultrasound scan file (USSD) based on predefined criteria, wherein the computing unit comprises a neural network, and
the computing unit assessing the ultrasound scan file (USSD) based on the predefined criteria.

2. A computer-implemented method according to claim 1, wherein the criteria are divided into test groups (1 QUSSD, 2 QWELD).

3. A computer-implemented method according to claim 2, wherein a test group defines the quality of the ultrasound scan file (1 QUSSD).

4. A computer-implemented method according to claim 3, wherein the ultrasound scan file (USSD) quality assessment includes the criterion of the profile of the displayed shaft in the ultrasound scan file (USSD) towards the inner and/or outer surface of the weld seam and the pipe.

5. A computer-implemented method according to claim 3, wherein the ultrasound scan file (USSD) quality assessment includes the criterion of the profile of the wall thickness in the ultrasound scan file (USSD) of the weld seam and the pipe.

6. A computer-implemented method according to claim 3, wherein the ultrasound scan file (USSD) quality assessment includes the criterion of the presence of a heating wire in the ultrasound scan file (USSD).

7. A computer-implemented method according to claim 2, wherein a test group defines the quality of the weld (2 QWELD).

8. A computer-implemented method according to claim 1, wherein the assessment of the quality of the weld includes at least one of the following criteria: anomalies, defects, or inconsistent, unexpected structures in the ultrasound scan file, no heating wire found.

9. A computer-implemented method according to claim 1, wherein the ultrasonic test for creating the ultrasound scan file (USSD) was carried out and created by way of time-of-flight diffraction (TOFD) or the phased-array ultrasonic test (PAUT).

10. A system for assessing a non-destructive ultrasonic test on a plastic pipe weld including an ultrasound scanner for carrying out an ultrasound scan on a plastic pipe weld and for creating an ultrasound scan file (USSD), a server for receiving the ultrasound scan file (USSD), a computing unit for analyzing the ultrasound scan file (USSD) and for assessing the ultrasound scan file based on the predefined criteria, wherein the computing unit comprises a neural network and an output unit (OUTPUT) for displaying the assessment.

11. A system according to claim 10, wherein the server has a web-based interface.

12. A method for training a neural network for use in a method for assessing a non-destructive ultrasonic test on a plastic pipe weld, preferably according to claim 1, including the following steps:
creating simulated ultrasound scan files (USSD) by way of the neural network of the computing unit based on known ultrasound scan files (USSD) of different materials,
assessing the ultrasound scan files (1 USSD, 2 QWELD) based on predefined criteria,
continuously expanding the neural network based on the simulated ultrasound scan files (USSD).

13. A method according to claim 12, wherein at least one of the predefined criteria is a profile of the displayed shaft in the ultrasound scan file towards the outer or inner surface of the weld seam and the pipe, a profile of the wall thickness in the ultrasound scan file of the weld seam and the pipe, an anomaly, a defect, or an inconsistent, unexpected structure in the ultrasound scan file or no heating wire found.

14. A method according to claim 12, wherein the neural network is a convolutional neural network (CNN).
